(19) United States
(12) Patent Application Publication
(10) Pub. No.: US 2024/0118381 A1
(43) Pub. Date: Apr. 11, 2024

(54) ROOFING SYSTEM WITH RADAR DEVICE, AND ASSOCIATED METHOD

(71) Applicant: BMIC LLC, Dallas, TX (US)

(72) Inventor: Igor Alovert, Morristown, NJ (US)

(21) Appl. No.: 18/484,206

(22) Filed: Oct. 10, 2023

Related U.S. Application Data
(60) Provisional application No. 63/415,129, filed on Oct. 11, 2022.

(51) Int. Cl. G01S 7/03; E04D 1/30; E04D 12/00; H02S 20/25

(52) U.S. Cl. CPC G01S 7/03; E04D 1/30; E04D 12/002; H02S 20/25; E04D 2001/308

(57) ABSTRACT

A roofing system including: a steep slope roof deck; and a radar device installed on the steep slope roof deck, where the radar device includes: a radio wave transceiver, where the radio wave transceiver generates a generated radio wave, and where the radio wave transceiver receives a reflected radio wave from an object detected by the generate radio wave; a dielectric antenna in electrical communication with the radio wave transceiver, where the dielectric antenna emits the generated radio wave, where the dielectric antenna receives the reflected radio wave, and where the dielectric antenna transmits the reflected radio wave to the radio wave transceiver; a computing device in electrical communication with the radio wave transceiver, where the computing device includes: a processor, and a non-transitory storage storing software, where the software operates the computing device, and where the processor determines, based on the reflected radio wave, at least one of a distance separating the radar device and the object, a direction in which the object is moving, a velocity of the object, and an identify of the object.

### CROSS-REFERENCE TO RELATED APPLICATION

This application claims the benefit of priority of U.S. provisional patent application No. 63/415,129, filed Oct. 11, 2022, the disclosure of which is incorporated by reference herein in its entirety.

### FIELD

The invention relates to a roofing system, and, more particularly, to a roofing system with a radar device and an associated method.

### BACKGROUND

An occupant of a residential structure with a steep slope roof, such as a house or other building, may desire to monitor events occurring within, and intrusions into, a space surrounding the structure, including an airspace around the roof.

### SUMMARY

The Claims, rather than the Summary, define covered embodiments of the present invention. The Summary is a high-level overview of various aspects of the invention, and introduces some of the concepts that are further described in the Detailed Description below. The Summary is not intended to identify key or essential features of the claimed subject matter, and also is not intended to be used in isolation to determine the scope of the claimed subject matter. The subject matter should be understood by reference to appropriate portions of the entire Specification, any or all drawings, and each claim.

In some embodiments, the present invention provides a roofing system comprising: a steep slope roof deck; and a radar device installed on the steep slope roof deck, wherein the radar device comprises: a radio wave transceiver, wherein the radio wave transceiver is configured to generate a generated radio wave, and wherein the radio wave transceiver is configured to receive a reflected radio wave that is reflected from an object detected by the generate radio wave; a dielectric antenna in electrical communication with the radio wave transceiver, wherein the dielectric antenna is configured to emit the generated radio wave, wherein the dielectric antenna is configured to receive the reflected radio wave, and wherein the dielectric antenna is configured to transmit the reflected radio wave to the radio wave transceiver; a computing device in electrical communication with the radio wave transceiver, wherein the computing device comprises: a processor, and a non-transitory storage configured to store software, wherein the software is configured to operate the computing device, and wherein the processor is configured to determine, based on the reflected radio wave received by the radio wave transceiver, at least one of a distance separating the radar device and the object, a direction in which the object is moving, a velocity of the object, and an identify of the object.

In some embodiments, a power supply is configured to provide power to at least one of the radio wave transceiver and the computing device of the radar device.

In some embodiments, the power supply comprises a photovoltaic shingle installed on the steep slope roof deck.

In some embodiments, the power supply comprises: a wireless power transmitter, and the radar device comprises a wireless power receiver that is configured to receive power transmitted by the wireless power transmitter.

In some embodiments, a ridge vent is installed on a ridge of the steep slope roof deck, and the radar device is located on a surface on the ridge vent.

In some embodiments, a ridge vent is installed on a ridge of the steep slope roof deck, and the radar device is located within an interior of the ridge vent.

In some embodiments, the steep slope roof deck is located on a residential structure.

In some embodiments, a plurality of roofing shingles is installed on the steep slope roof deck, and the radar device is located on a surface of at least one roofing shingle of the plurality of roofing shingles.

In some embodiments, a plurality of roofing shingles is installed on the steep slope roof deck, and the radar device is located within an interior of at least one roofing shingle of the plurality of roofing shingles.

In some embodiments, a plurality of roofing shingles is installed on the steep slope roof deck, and the radar device is located underneath at least one roofing shingle of the plurality of roofing shingles.

In some embodiments, an underlayment is installed on a surface of the steep slope roof deck; a plurality of roofing shingles is installed on the underlayment, and the radar device is located on a surface of the underlayment.

In some embodiments, an underlayment is installed on a surface of the steep slope roof deck; a plurality of roofing shingles is installed on the underlayment, and the radar device is located within an interior of the underlayment.

In some embodiments, an underlayment is installed on a surface of the steep slope roof deck; a plurality of roofing shingles installed on the underlayment, and the radar device is located under the underlayment between the underlayment and the surface of the steep slope roof deck.

In some embodiments, a plurality of photovoltaic shingles is installed on the steep slope, at least one of the photovoltaic shingles comprises a wireway; and the radar device is located within the wireway.

In some embodiments, a plurality of photovoltaic shingles is installed on the steep slope roof deck, each of the photovoltaic shingles comprises a photovoltaic layer including at least one solar cell, and a backsheet, wherein the photovoltaic layer is located above the backsheet, and the radar device is located within the backsheet. In some embodiments, a plurality of photovoltaic shingles is installed on the steep slope roof deck, each of the photovoltaic shingles comprises at least one solar cell, and at least one backsheet, the solar cell is located above the backsheet, and the radar device is located on a surface of the backsheet.

In some embodiments, a plurality of photovoltaic shingles is installed on the steep slope roof deck, each of the photovoltaic shingles comprises a photovoltaic layer including at least one solar cell, and a backsheet, where the photovoltaic layer is located above the backsheet, and the radar device is located at least partially embedded within the backsheet.

In some embodiments, a second radar device is installed on the steep slope roof deck, and the second radar device comprises a second radio wave transceiver, and a second dielectric antenna in electrical communication with the second radio wave transceiver.

In some embodiments, the present invention provides a method, comprising: generating, with a radio wave transceiver installed on a steep slope roof deck, a generated radio wave; emitting, through a dielectric antenna in electrical communication with the radio wave transceiver, the generated radio wave; receiving, through the dielectric antenna, a reflected radio wave that is reflected from an object detected by the generated radio wave, wherein the object is over the steep slope roof deck; transmitting, through the dielectric antenna to the radio wave transceiver, the reflected radio wave; determining, with a computing device in electrical communication with the radio wave transceiver, the computing device including a processor connected to a non-transitory memory with stored software, based on the second radio wave, a characteristic of the object, wherein the characteristic of the object includes at least one of: a distance separating the radar device and the object, a direction in which the object is moving, and a velocity of the object; and detecting, based at least in part on the determined characteristic, an identity of the object, wherein the object is at least one of: a drone, a bird, and a missile.

In some embodiments, a power supply powers at least one of the radio wave transceiver and the computing device of the radar device.

In some embodiments, the power supply comprises a photovoltaic shingle installed on the steep slope roof deck.

In some embodiments, the power supply comprises a wireless power transmitter, the radar device comprises a wireless power receiver.

In some embodiments the wireless power transmitter transmits power; and the wireless power receiver receives power transmitted by the wireless power transmitter.

In some embodiments, the radar device is located on a surface on a ridge vent installed on a ridge of the steep slope roof deck.

In some embodiments, the radar device is located within an interior of a ridge vent installed on a ridge of the steep slope roof deck.

In some embodiments, the radar device is located on a surface of a roofing shingle installed of the steep slope roof deck.

In some embodiments, the radar device is located within an interior of a roofing shingle installed on the steep slope roof deck.

In some embodiments, the radar device is located underneath a roofing shingle installed on the steep slope roof deck.

In some embodiments, the radar device is located on a surface of an underlayment installed on the steep slope roof deck.

In some embodiments, the radar device is located within an interior of an underlayment installed on the steep slope roof deck.

In some embodiments, the radar device is located under an underlayment installed under a roofing shingle, and the radar device is located between the underlayment and a surface of the steep slope roof deck.

In some embodiments, the radar device is located within a wireway of a photovoltaic shingle installed on the steep slope roof deck.

In some embodiments, the radar device is located within a backsheet of a photovoltaic shingle.

In some embodiments, the radar device is located on a surface of a backsheet of a photovoltaic shingle.

In some embodiments, the radar device is located at least partially embedded within a backsheet of a photovoltaic shingle

### BRIEF DESCRIPTION OF THE DRAWINGS

This section refers to the drawings that form a part of this disclosure, and which illustrate embodiments of materials and methods described herein.

FIG. 1 is a block diagram of a roofing system, in accordance with some embodiments of the invention.

FIG. 2 is a block diagram of a method associated with the roofing system, in accordance with some embodiments of the invention.

### DETAILED DESCRIPTION

In addition to the benefits and improvements that the Specification discloses, other objects and advantages that the Specification provides will become apparent from the following description taken in conjunction with the accompanying figures. Although the description discloses and describes detailed embodiments of the present disclosure, the disclosed embodiments are merely illustrative of the disclosure that may be embodied in various forms. In addition, each of the examples given regarding the various embodiments of the disclosure are intended to be illustrative, and not restrictive.

Throughout the specification and claims, the following terms take the meanings explicitly associated herein, unless the context clearly dictates otherwise. The phrases “in an embodiment,” “in some embodiments,” and any similar phrase, as used herein, do not necessarily refer to the same embodiment or embodiments, though the phrases may refer to the same embodiment or embodiments. Furthermore, the phrases “in another embodiment,” and any similar phrase, as used herein, do not necessarily refer to a different embodiment, although the phrases may refer to a different embodiment. All embodiments of the disclosure are intended to be combinable without departing from the scope or spirit of the disclosure.

As used herein, terms such as “comprising,” “including,” “having,” and any similar phrase, do not limit the scope of a specific claim to the materials or steps recited by the claim.

As used herein, a “steep slope” roof or roof deck is a roof or roof deck that is disposed on a building, such as a house or other residential structure, having a pitch of Y/X, where Y and X are in a ratio of 4:12 to 20:12, where Y corresponds to the “rise” of the roof, and where X corresponds to the “run” of the roof.

As used herein, a “sloped” roof or roof deck is a roof or roof deck that is disposed on a building, such as a house or other residential structure, having a pitch that is less than that of a steep slope roof or roof deck, but which is not a flat roof or roof deck.

In some embodiments, as described herein, the present invention may provide a radar device installed on or otherwise associated with a steep slope roof or roof deck. In some embodiments, the radar device may monitor intrusions and/or other events occurring within or adjacent to an airspace of the steep slope roof or roof deck.

In some embodiments, as described herein, the present invention may provide a radar device installed on or otherwise associated with a sloped roof or roof deck. In some embodiments, the radar device may monitor intrusions and/or other events occurring within or adjacent to an airspace of the sloped roof or roof deck.

In some embodiments, the radar device may include a radio wave transceiver. In some embodiments, the radio wave transceiver may be configured to generate, and/or may generate, a generated radio wave. In some embodiments, the radio wave transceiver may be configured to receive, and/or may receive, a reflected radio wave that is reflected from an object detected by the generate radio wave.

In some embodiments, the radar device may include a dielectric antenna. In some embodiments, the dielectric antenna may be in electrical communication with the radio wave transceiver. In some embodiments, the dielectric antenna may be configured to emit, and/or may emit, the generated radio wave. In some embodiments, the dielectric antenna may be configured to receive, and/or may receive, the reflected radio wave. In some embodiments, the dielectric antenna may be configured to transmit, and/or may transmit, the reflected radio wave to the radio wave transceiver.

In some embodiments, the radar device may include a computing device. In some embodiments, the computing device may be in electrical communication with the radio wave transceiver.

In some embodiments, the computing device may include a processor. In some embodiments, the computing device may include a non-transitory storage. In some embodiments, the non-transitory storage may be at least one of: a memory (such as but not limited to ROM or RAM), a disc, a hard drive, the cloud, or other storage. In some embodiments, the storage may be configured to store, and/or may store, software. In some embodiments, the software may be configured to operate, and/or may operate, the computing device.

In some embodiments, the processor may be configured to determine, and/or may determine, based on the reflected radio wave received by the radio wave transceiver, a distance separating the radar device and the object. In some embodiments, the processor may be configured to determine, and/or may determine, based on the reflected radio wave received by the radio wave transceiver, a direction in which the object is moving. In some embodiments, the processor may be configured to determine, and/or may determine, based on the reflected radio wave received by the radio wave transceiver, a velocity of the object. In some embodiments, the processor may be configured to determine, and/or may determine, based on the reflected radio wave received by the radio wave transceiver, an identify of the object. In some embodiments, the processor may be configured to determine, and/or may determine, based on the reflected radio wave received by the radio wave transceiver, at least one of the distance separating the radar device and the object, the direction the object is moving, the velocity of the object, and/or the identity of the object. In some embodiments, the processor may be configured to determine, and/or may determine, based on the reflected radio wave received by the radio wave transceiver, two, three, or all four of: the distance separating the radar device and the object, the direction the object is moving, the velocity of the object, and/or the identity of the object.

In some embodiments, the radar device may be installed on the steep slope roof deck of a residential structure. In some embodiments, the structure may be a house. In some embodiments, the structure may be a building other than a house.

In some embodiments, a power supply may be configured to provide, and/or may provide, power to at least one of the radio wave transceiver and/or the computing device of the radar device. In some embodiments, a power supply may be configured to provide, and/or may provide, power to one or more other components of the radar device.

In some embodiments, the power supply may include one or more photovoltaic shingles installed on the steep slope roof deck. In some embodiments, the one or more photovoltaic shingles may be disposed directly on the steep slope roof deck—that is, there may be no intervening layer between a surface of the steep slope roof deck and the photovoltaic shingles. In some embodiments, the one or more photovoltaic shingles may be disposed above on the steep slope roof deck, and there may be one or more intervening layers between the surface of the steep slope roof deck and the photovoltaic shingles.

In some embodiments, the power supply may include a wireless power transmitter, which may be configured to provide, and/or may provide, power. In some embodiments, the radar device may include a wireless power receiver that may be configured to receive, and/or may receive, power transmitted by the wireless power transmitter.

In some embodiments, the power supply may be located on the roof deck. In some embodiments, the power supply may be located in an attic. In some embodiments, the power supply may be located in the structure covered by the roof deck. In some embodiments, the power supply may include one or more wires connecting components of the power supply to one another, and/or to one or more components of the radar device.

In some embodiments, one or more ridge vents may be installed on a ridge of the steep slope roof deck. In some embodiments, one ridge vent may be used. In some embodiments, more than one ridge vent may be used. In some embodiments, at least a portion of the radar device may be located on a surface on the ridge vent. In some embodiments, at least a portion of the radar device may be located on a top surface on the ridge vent. In some embodiments, at least a portion of the radar device may be located on a bottom surface on the ridge vent. In some embodiments, at least a portion of the radar device may be located within an interior of the ridge vent.

In some embodiments, one or more roofing shingles may be installed on the steep slope roof deck. In some embodiments, the radar device may be located on a surface of at least one roofing shingle. In some embodiments, the radar device may be located on a top surface of at least one roofing shingle. In some embodiments, the radar device may be located on a bottom surface of at least one roofing shingle. In some embodiments, the radar device may be located within an interior of at least one roofing shingle. In some embodiments, the radar device may be located underneath at least one roofing shingle, such as between the roofing shingle and a surface of the steep slope roof deck.

In some embodiments, an underlayment may be installed on a surface of the steep slope roof deck. In some embodiments, the radar device may be located on a surface of the underlayment. In some embodiments, the radar device may be located within an interior of the underlayment. In some embodiments, the radar device may be located under the underlayment between the underlayment and the surface of the steep slope roof deck. In some embodiments, one or more roofing shingles may be installed on the underlayment. In some embodiments, the radar device may be located between the roofing shingle and a surface of the underlayment.

In some embodiments, one or more photovoltaic shingles may be installed on the steep slope roof deck. In some embodiments, one or more of the photovoltaic shingles include a wireway, including one or more electrical connections connecting the photovoltaic shingle to another photovoltaic shingle and/or another component of an electrical power system associated with the photovoltaic shingle. In some embodiments, the radar device may be located within one of the wireways.

In some embodiments, one or more of the photovoltaic shingles may include a photovoltaic layer with at least one solar cell, and a backsheet, where the photovoltaic layer is located above the backsheet. In some embodiments, the radar device may be located within the backsheet. In some embodiments, the radar device may be located on a surface of the backsheet. In some embodiments, the radar device may be located on a top surface of the backsheet. In some embodiments, the radar device may be located on a bottom surface of the backsheet. In some embodiments, the radar device may be located at least partially embedded within the backsheet.

In some embodiments, the present invention may include a plurality of radar devices. In some embodiments, the plurality of radar devices may include two radar devices. In some embodiments, the plurality of radar devices may include more than two radar devices. In some embodiments, one radar device may be on one surface of a roof deck. In some embodiments, one radar device may be on each surface of a roof deck. In some embodiments, multiple radar devices may be on each surface of a roof deck. In some embodiments, one radar device may be on the roof deck. In some embodiments, each of the radar devices may be in accordance with the radar device discussed herein. For example, in some embodiments, each of the radar devices may include a radio wave transceiver as described herein, and/or a dielectric antenna as described herein, and/or a computing device as described herein.

In some embodiments, the present invention may disclose a method, associated with the discussed apparatus. Thus, in some embodiments, the computing device may determine, with the program stored in the storage, the program operating the processor, a characteristic of the object in the space above the radar device. In some embodiments, the characteristic of the object may include at least one of: a distance separating the radar device and the object, a direction in which the object is moving, and/or a velocity of the object.

In some embodiments, the computing device may detect, based at least in part on one or more of the determined characteristic, an identity of the object. In some embodiments, the object may be any object that is above or within the space surrounding the structure. In some embodiments, the computing device may identify the object as one of a drone, a bird, and a missile. In some embodiments, the computing device may identify the object as something other than a drone, a bird, or a missile. For example, in some embodiments, the computing device may compare one or more of the determined characteristics with stored characteristics of a drone, bird, or missile, and based on a result of the comparison, output an identity of the object. For example, in some embodiments, the identity of the object, and/or the determined characteristic of the object, may be output by being displayed on a display connected to the processor.

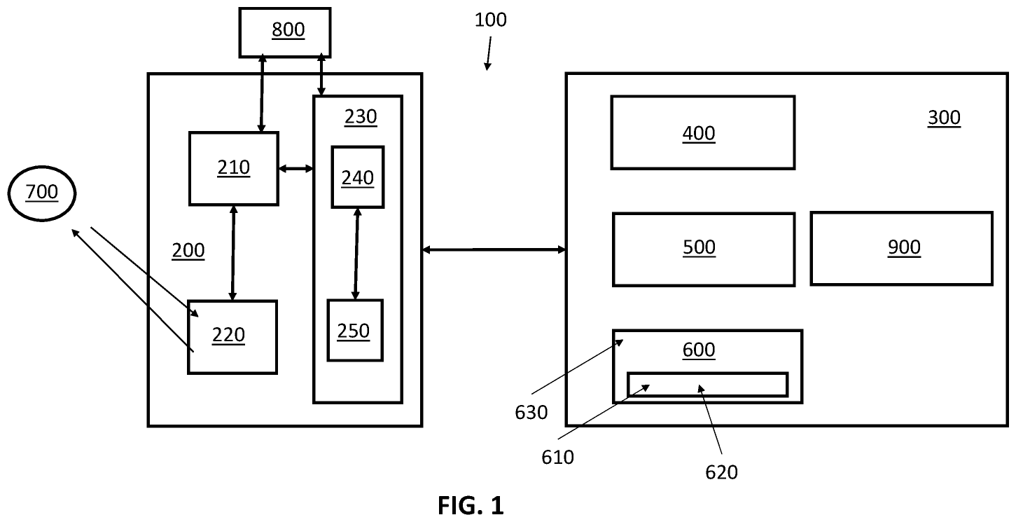

With reference to the drawings, FIG. 1 illustrates a block diagram of a roofing system 100 in accordance with some embodiments of the invention, as described herein.

As shown, the roofing system 100 may include a radar device 200, which may be installed on or above, or otherwise associated with a steep slope roof deck 300. In some embodiments, components of the roofing system 100 may be installed on or above, or otherwise associated with, a sloped roof deck.

In some embodiments, the steep slope roof deck 300 may include none, any, one or more, or all of: one or more roofing shingles 400, an underlayment 500, one or more photovoltaic shingles 600, and/or one or more ridge vents 900, as described herein. For example, one or more of the photovoltaic shingles 600 may include a photovoltaic layer 610, which may include one, two, three, four, or more solar cells 620; and a backsheet 630, and the photovoltaic layer 610 may be disposed above the backsheet 630, as described herein.

In some embodiments, as FIG. 1 shows, the radar device 200 may include a radio wave transceiver 210. The radio wave transceiver 210 may be as described herein. For example, in some embodiments, the radio wave transceiver 210 may be configured to generate, and/or may generate, a radio wave.

In some embodiments, as the figure illustrates, the radar device 200 may include a dielectric antenna 220. The dielectric antenna 220 may be as described herein. For example, in some embodiments, the dielectric antenna 220 may be in electrical communication with the radio wave transceiver 210. In some embodiments, the dielectric antenna 220 may be configured to emit, and/or may emit, the generated radio wave. In some embodiments, the dielectric antenna may be configured to receive, and/or may receive, a reflected radio wave that is reflected from an object 700 that is detected by the generate radio wave. Restated, in some embodiments, the generated and emitted radio wave may detect the object 700, and the object 700 may reflect back a reflected radio wave that corresponds to, but which may be either the same as or different than the generated and emitted radio wave. In some embodiments, the dielectric antenna 220 may be configured to transmit, and/or may transmit, the received, reflected radio wave back to the radio wave transceiver 210.

As shown in FIG. 1, the radar device 200 may include a computing device 230. The computing device 230 may be as described herein. Thus, for example, in some embodiments, the computing device 230 may be in electrical communication with the radio wave transceiver 210, and/or with the dielectric antenna 220. In some embodiments, the computing device 230 may include a processor 240. In some embodiments, the computing device 230 may include a non-transitory storage or memory 250 configured to store, and/or that stores, software. In some embodiments, the software may be configured to operate, and/or may operate, the processor 240 and/or any other component or components of the computing device 230 and/or the radar device 200. In some embodiments, the processor 240 may be configured to determine, and/or may determine, based on the reflected radio wave received by the radio wave transceiver 210 from the dielectric antenna 220, at least one of characteristic of or related to the object 700. In some embodiments, the characteristic includes at least one of: a distance separating the radar device 200 and the object 700, a direction in which the object 700 is moving, a velocity of the object 700, and/or an identify of the object 700. In some embodiments, the computing device 230 may identify whether object 700 is one of the following: a drone, a bird, an animal, a human, a missile, an object falling from the sky such as from a satellite or an aircraft, or another object.

As FIG. 1 shows, the roofing system 100 may include a power supply 800. In some embodiments, the power supply 800 may be as described herein. For example, the power supply 800 may be configured to provide power to at least one of the radio wave transceiver 210 and/or the computing device 230, and/or any other component or components of the radar device 200. In some embodiments, power supply 800 may be one or more of the photovoltaic shingles 600.

As described herein, in some embodiments, the power supply 800 may include a wireless power transmitter. The wireless power transmitter may be as described herein. For example, in some embodiments, the wireless power transmitter may be configured to transmit, and/or may transmit, power wirelessly. In some embodiments, the radar device 200 may include a wireless power receiver that is configured to receive, and/or that receives, the wireless power that is transmitted by the wireless power transmitter.

As described herein, one or more components of the radar device 200, such as any or all of radio wave transceiver 210, the dielectric antenna 220, and the computing device 230, may be associated with the various components on the steep slope roof or roof deck. For example, one or more components of radar device 200 may be: located, either fully or partially, on a top, bottom, or other surface on the ridge vent 900; located, either fully or partially, within an interior of the ridge vent 900; located, either fully or partially, on a top, bottom, or other surface of at least one roofing shingle 400; located, either partially or fully, within an interior of at least one roofing shingle 400; located, either partially or fully, underneath at least one roofing shingle 400; located, either partially or fully, on a top, bottom, or other surface of the underlayment 500; located, either partially or fully, within an interior of the underlayment 500; located, either partially or fully, under the underlayment 500; located, either partially or fully, between the underlayment 500 and the surface of the steep slope roof deck 300; located, either partially or fully, within a wireway of at least one or more photovoltaic shingles 600; located, either partially or fully, within the backsheet 630 of at least one or more photovoltaic shingles 600; located, either partially or fully, on a surface of the backsheet 630 of at least one or more photovoltaic shingles 600; and/or located, either partially or fully, embedded within the backsheet 630 of at least one or more photovoltaic shingles 600; among other locations.

Also as described herein, although FIG. 1 shows only one radar device 200, the roofing system 100 may include more than one radar device 200. In some embodiments, each of the radar devices 200 may be as described herein.

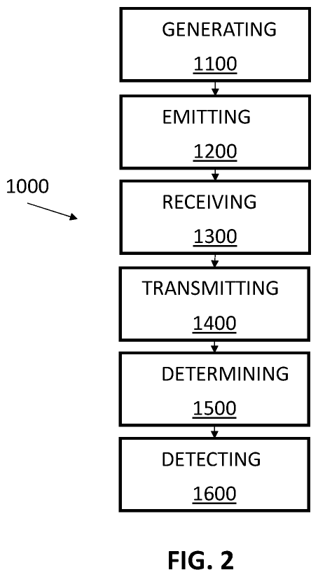

FIG. 2 is a block diagram of a method 1000 associated with the roofing system 100 as described herein, in accordance with some embodiments of the invention. As shown in FIG. 2, the method 1000 may include a generating step 1100, which may include generating, with the radio wave transceiver 210 installed on or associated with the steep slope roof deck 300, the generated radio wave, as described. The method 1000 may include an emitting step 1200, which may include emitting, through the dielectric antenna 220 in electrical communication with the radio wave transceiver 210, the generated radio wave, as described.

The method 1000 may include a receiving step 1300, which may include receiving, through the dielectric antenna 220, the reflected radio wave that is reflected from the object 700 detected by the generated radio wave, wherein the object 700 is adjacent to or within an airspace or otherwise over the steep slope roof deck 300, as described. The method 1000 may include a transmitting step 1400, which may include transmitting, through the dielectric antenna 220 to the radio wave transceiver 210, the reflected radio wave, as described.

The method 1000 may include a determining step 1500, which may include determining, with the computing device 230 in electrical communication with the radio wave transceiver 210, the computing device 230 including the processor 240 connected to the non-transitory storage or memory 250 with stored software, based on the reflected radio wave, a characteristic of the object 700, as described. Also as discussed, in some embodiments, the characteristic of the object 700 may include at least one or more of, or all of, the distance separating the radar device 200 and the object 700, the direction in which the object 700 is moving, and/or the velocity of the object 700.

The method 1000 may include a detecting step 1600. The detecting step 1600 may include detecting, based at least in part on the determined characteristic, the identity of the object 700, a described. As discussed, in some embodiments, the object may be detected and may be identified as a drone, a bird, an animal, a human, or a missile, or as another object.

Variations, modifications and alterations to embodiments of the present disclosure described above will make themselves apparent to those skilled in the art. All such variations, modifications, alterations and the like are intended to fall within the spirit and scope of the present disclosure, limited solely by the appended claims.

While several embodiments of the present disclosure have been described, it is understood that these embodiments are illustrative only, and not restrictive, and that many modifications may become apparent to those of ordinary skill in the art. For example, all dimensions discussed herein are provided as examples only, and are intended to be illustrative and not restrictive.

Any feature or element that is positively identified in this description may also be specifically excluded as a feature or element of an embodiment of the present as defined in the claims.

The disclosure described herein may be practiced in the absence of any element or elements, limitation or limitations, which is not specifically disclosed herein. Thus, for example, in each instance herein, any of the terms “comprising,” “consisting essentially of” and “consisting of” may be replaced with either of the other two terms, without altering their respective meanings as defined herein. The terms and expressions which have been employed are used as terms of description and not of limitation, and there is no intention in the use of such terms and expressions of excluding any equivalents of the features shown and described or portions thereof, but it is recognized that various modifications are possible within the scope of the disclosure.

1. A roofing system comprising:
a steep slope roof deck; and
a radar device installed on the steep slope roof deck,
wherein the radar device comprises:
a radio wave transceiver,
wherein the radio wave transceiver is configured to generate a generated radio wave, and
wherein the radio wave transceiver is configured to receive a reflected radio wave that is reflected from an object detected by the generated radio wave;
a dielectric antenna in electrical communication with the radio wave transceiver,
wherein the dielectric antenna is configured to emit the generated radio wave,
wherein the dielectric antenna is configured to receive the reflected radio wave, and
wherein the dielectric antenna is configured to transmit the reflected radio wave to the radio wave transceiver;
a computing device in electrical communication with the radio wave transceiver,
wherein the computing device comprises:
a processor, and
a non-transitory storage configured to store software,
wherein the software is configured to operate the computing device, and
wherein the processor is configured to determine,
based on the reflected radio wave received by the radio wave transceiver, at least one of
a distance separating the radar device and the object,
a direction in which the object is moving,
a velocity of the object, or
an identity of the object.

2. The roofing system of claim 1, further comprising:
a power supply configured to provide power to at least one of the radio wave
transceiver and the computing device of the radar device,
wherein the power supply comprises a photovoltaic shingle installed on the steep slope roof deck.

3. The roofing system of claim 1, further comprising:
a ridge vent installed on a ridge of the steep slope roof deck,
wherein the radar device is located on a surface on the ridge vent.

4. The roofing system of claim 1, further comprising:
a ridge vent installed on a ridge of the steep slope roof deck,
wherein the radar device is located within an interior of the ridge vent.

5. The roofing system of claim 1, further comprising:
a plurality of roofing shingles installed on the steep slope roof deck,
wherein the radar device is located on a surface of at least one roofing shingle of the plurality of roofing shingles.

6. The roofing system of claim 1, further comprising:
a plurality of roofing shingles installed on the steep slope roof deck,
wherein the radar device is located within an interior of at least one roofing shingle of the plurality of roofing shingles.

7. The roofing system of claim 1, further comprising:
a plurality of roofing shingles installed on the steep slope roof deck,
wherein the radar device is located underneath at least one roofing shingle of the plurality of roofing shingles.

8. The roofing system of claim 1, further comprising:
an underlayment installed on a surface of the steep slope roof deck; and
a plurality of roofing shingles installed on the underlayment,
wherein the radar device is located on a surface of the underlayment.

9. The roofing system of claim 1, further comprising:
an underlayment installed on a surface of the steep slope roof deck; and
a plurality of roofing shingles installed on the underlayment,
wherein the radar device is located within an interior of the underlayment.

10. The roofing system of claim 1, further comprising:
an underlayment installed on a surface of the steep slope roof deck; and
a plurality of roofing shingles installed on the underlayment,
wherein the radar device is located under the underlayment between the underlayment and the surface of the steep slope roof deck.

11. The roofing system of claim 1, further comprising:
a plurality of photovoltaic shingles installed on the steep slope roof deck,
wherein each of the photovoltaic shingles comprises
a photovoltaic layer including at least one solar cell, and
a backsheet,
wherein the photovoltaic layer is located above the backsheet, and
wherein the radar device is located within the backsheet.

12. The roofing system of claim 1, further comprising:
a plurality of photovoltaic shingles installed on the steep slope roof deck,
wherein each of the photovoltaic shingles comprises
a photovoltaic layer including at least one solar cell, and
a backsheet,
wherein the photovoltaic layer is located above the backsheet, and
wherein the radar device is located on a surface of the backsheet.

13. A method, comprising:
generating, with a radio wave transceiver of a radar device installed on a steep slope roof deck, a generated radio wave;
emitting, through a dielectric antenna of the radar device, which is in electrical communication with the radio wave transceiver, the generated radio wave;
receiving, through the dielectric antenna, a reflected radio wave that is reflected from an object detected by the generated radio wave,
wherein the object is over the steep slope roof deck;
transmitting, through the dielectric antenna to the radio wave transceiver, the reflected radio wave;
determining, with a computing device in electrical communication with the radio wave transceiver, the computing device including a processor connected to a non-transitory memory with stored software, based on the reflected radio wave, a characteristic of the object,
wherein the characteristic of the object includes at least one of:
a distance separating the radar device and the object,
a direction in which the object is moving, and
a velocity of the object,
an identity of the object.

14. The method of claim 13, further comprising:
powering, with a power supply, at least one of the radio wave transceiver and the
computing device of the radar device,
wherein the power supply comprises a photovoltaic shingle installed on the steep slope roof deck.

15. The method of claim 13, wherein the radar device is located on a surface of or within a ridge vent installed on a ridge of the steep slope roof deck.

16. The method of claim 13, wherein the radar device is located on a surface of or within a roofing shingle installed of the steep slope roof deck.

17. The method of claim 13, wherein the radar device is located on a surface of or within an underlayment installed on the steep slope roof deck.

18. The method of claim 13, wherein the radar device is located within a wireway of a photovoltaic shingle installed on the steep slope roof deck.

19. The method of claim 13, wherein the radar device is located on a surface of or within a backsheet of a photovoltaic shingle installed on the steep slope roof deck.

20. The method of claim 13, wherein the radar device is located on a surface of or within a roofing shingle installed on the steep slope roof deck.
